(19) United States
(12) Patent Application Publication
(10) Pub. No.: US 2026/0060272 A1
(43) Pub. Date: Mar. 5, 2026

(54) INFRARED-SENSING COLD BEVERAGE MAKER

(71) Applicant: Guangdong Welly Electrical Appliances Co., Ltd., Zhongshan (CN)

(72) Inventors: Xiangan Wu, Zhongshan (CN); Linjun Mai, Zhongshan (CN); Yangyang Ma, Zhongshan (CN); Wenzhan Hu, Zhongshan (CN)

(21) Appl. No.: 19/082,164

(22) Filed: Mar. 17, 2025

(30) Foreign Application Priority Data
Aug. 29, 2024 (CN) 202422120855.X

(51) Int. Cl. A23G 9/22; A23G 9/12; A23G 9/28; A23G 9/52

(52) U.S. Cl. CPC A23G 9/228; A23G 9/12; A23G 9/224; A23G 9/281; A23G 9/52

(57) ABSTRACT

The present disclosure provides an infrared-sensing cold beverage maker, including a discharge device, a sensing device, a refrigeration stirring assembly, and a drive that are mounted on a body, where the discharge device is provided with a handle; the sensing device is opposite to the handle; the sensing device is electrically connected to the drive; and the sensing device is configured to identify a use state of the handle, so as to adjust an operating state of the drive. The present disclosure solves the problem that the stirring system in the conventional cold beverage maker often operates continuously even in case of no discharge requirement to result in deterioration of the ice cream or the smoothie for longtime stirring.

### CROSS REFERENCE TO RELATED APPLICATIONS

The present application claims the benefit of Chinese Patent Application No. 202422120855X filed on Aug. 29, 2024, the contents of which are incorporated herein by reference in their entirety.

### TECHNICAL FIELD

The present disclosure relates to the technical field of cold beverage makers, and in particular to an infrared-sensing cold beverage maker.

### BACKGROUND

For the cold beverage maker, in order to ensure that ice cream or smoothie can reach a desired low temperature quickly and stably in the making process, continuously stirring the ice cream or the smoothie is required to realize efficient heat exchange with the refrigerating cylinder. The cold beverage maker cannot adjust the stirring speed and the stirring frequency according to a present working state, but often operates continuously.

With longtime stirring, water in the ice cream or the smoothie will be gradually crystallized into ice sludge. This not only affects the delicate mouthfeel of the ice cream or the smoothie, but also makes the whole texture of the ice cream or the smoothie coarse to affect eating experience of consumers. Besides, due to the continuous stirring required in the making process of the cold beverage maker, the motor may operate for a long time. Thus, components in the motor will be aged and worn easily to shorten the service life of the motor.

### SUMMARY

In view of the above defect, the present disclosure provides an infrared-sensing cold beverage maker. With cooperation among the sensing device, the drive and the refrigeration stirring assembly, the present disclosure starts a corresponding working mode only in case of a real discharge requirement. This solves the problem that the stirring system in the conventional cold beverage maker often operates continuously even in case of no discharge requirement to result in deterioration of the ice cream or the smoothie for longtime stirring.

In order to achieve the above objective, the present disclosure adopts the following technical solutions:

The present disclosure provides an infrared-sensing cold beverage maker, including a discharge device, a sensing device, a refrigeration stirring assembly, and a drive that are mounted on a body, where the discharge device is provided with a handle; the sensing device is opposite to the handle; the sensing device is electrically connected to the drive; the sensing device is configured to identify a use state of the handle, so as to adjust an operating state of the drive; and the drive is configured to adjust a stirring speed of the refrigeration stirring assembly.

The sensing assembly includes an infrared generator and an infrared receiver; the infrared receiver is electrically connected to the drive; the infrared generator is configured to emit infrared light to the handle; and the infrared receiver is configured to receive infrared light reflected by the handle.

The infrared generator and the infrared receiver are respectively located at two sides of the handle; and the infrared generator, the infrared receiver and the handle form a triangular structure.

The refrigeration stirring assembly includes a propeller and a refrigerating cylinder; the propeller is rotatably mounted in the refrigerating cylinder; a length direction of the propeller is the same as a length direction of the refrigerating cylinder; and an output end of the drive is fixedly connected to the propeller.

The discharge device further includes a discharge disc; the discharge disc is configured to seal the refrigerating cylinder; the discharge disc is provided with a first discharge port; the first discharge port communicates with an interior of the refrigerating cylinder; a bottom of the handle is provided with a transmission assembly and a sealing element; the transmission assembly is connected to the handle and the sealing element; and the sealing element is configured to open or close the first discharge port.

The transmission assembly includes a first transmission element and a second transmission element; the handle includes a first hinge point rotatably mounted on a top of the discharge disc at the first discharge port, and a second hinge point rotatably connected to a top of the first transmission element; a bottom of the first transmission element is connected to a top of a rear side of the second transmission element; and a bottom of the second transmission element is fixedly connected to the sealing element; and
in an initial state, a direction of a connecting line for the first hinge point and the second hinge point is a horizontal direction.

The transmission assembly further includes a return torsion spring; the return torsion spring sequentially includes a winding portion and a transmission portion from top to bottom; the winding portion is wound on the first hinge point of the handle; and the transmission portion is fixedly connected to a front side of the second transmission element.

The refrigeration stirring assembly further includes a cooling tube; and the cooling tube is provided around an outer side of the refrigerating cylinder.

The technical solutions provided by the present disclosure may have the following beneficial effects:
1. With cooperation among the sensing device, the drive and the refrigeration stirring assembly, the present disclosure starts a corresponding working mode only in case of a real discharge requirement. This solves the problem that the stirring system in the conventional cold beverage maker often operates continuously even in case of no discharge requirement to result in deterioration of the ice cream or the smoothie for longtime stirring.
2. With cooperation between the infrared generator and the infrared receiver, the present disclosure can accurately determine whether a discharge operation is required by the present cold beverage maker, and correspondingly adjust the operating state of the drive and the operating state of the refrigeration stirring assembly. Such an instant response mechanism ensures that the ice cream or the smoothie is pushed out at the best time, keeps the original flavor and mouthfeel of the ice cream or the smoothie, and prevents the unnecessary energy waste.

### BRIEF DESCRIPTION OF THE DRAWINGS

FIG. 1 is a schematic view of a cold beverage maker according to an embodiment of the present disclosure;

FIG. 2 is an enlarged view of A shown in FIG. 1;

FIG. 3 is an exploded view of a cold beverage maker according to an embodiment of the present disclosure;

FIG. 4 is an exploded view of a transmission assembly and a handle according to an embodiment of the present disclosure; and

FIG. 5 is a schematic structural view of a sealing element and a second transmission element according to an embodiment of the present disclosure.

### IN THE FIGURES

1: body, 2: discharge device, 21: handle, 22: discharge disc, 23: transmission assembly, 24: sealing element, 241: second sealing clamping member, 242: elastic protrusion portion, 243: hook portion, 25: first transmission element, 26: second transmission element, 261: sealing chute, 262: first sealing clamping member, 27: return torsion spring, 3: sensing device, 31: infrared generator, 32: infrared receiver, 4: refrigeration stirring assembly, 41: propeller, and 42: refrigerating cylinder.

### DETAILED DESCRIPTION

The technical solutions of the present disclosure will be further described below with reference to the accompanying drawings and specific implementations.

In the description of the present disclosure, it should be understood that orientation or position relationships indicated by terms “length”, “middle”, “upper”, “lower”, “left”, “right”, “top”, “bottom”, and the like are orientation or position relationships as shown in the drawings, and these terms are just used to facilitate description of the present disclosure and simplify the description, but not to indicate or imply that the mentioned apparatus or element must have a specific orientation and must be constructed and operated in a specific orientation. Thus, these terms cannot be understood as a limitation to the present disclosure.

In addition, the terms “first” and “second” are merely intended for a purpose of description, and shall not be understood as an indication or implication of relative importance or implicit indication of a quantity of indicated technical features. Thus, features defined with “first” and “second” may explicitly or implicitly include one or more of the features. In the description of the present disclosure, unless otherwise specified, “a plurality of” means at least two.

In the description of the present disclosure, it should be noted that, unless otherwise clearly specified and limited, meanings of terms “mount”, “splice”, and “connect” should be understood in a broad sense. For example, the “connect” may be a fixed connection, a removable connection or an integrated connection, may be a direct connection or an indirect connection implemented by using an intermediate medium, and may be intercommunication between two components. Those of ordinary skill in the art may understand specific meanings of the above terms in the present disclosure based on a specific situation. Those of ordinary skill in the art may understand specific meanings of the above terms in the present disclosure based on a specific situation.

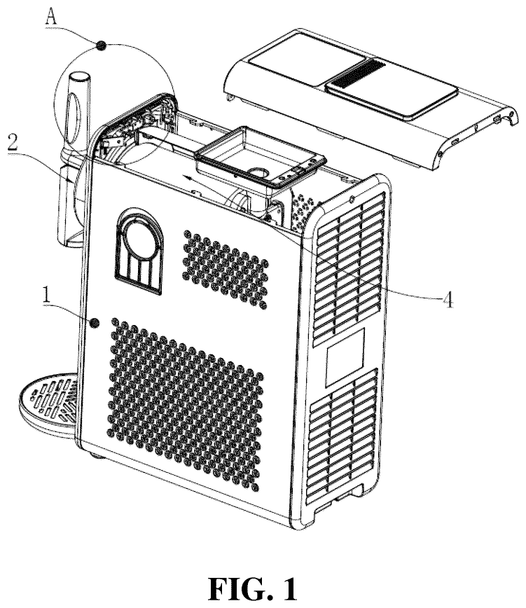

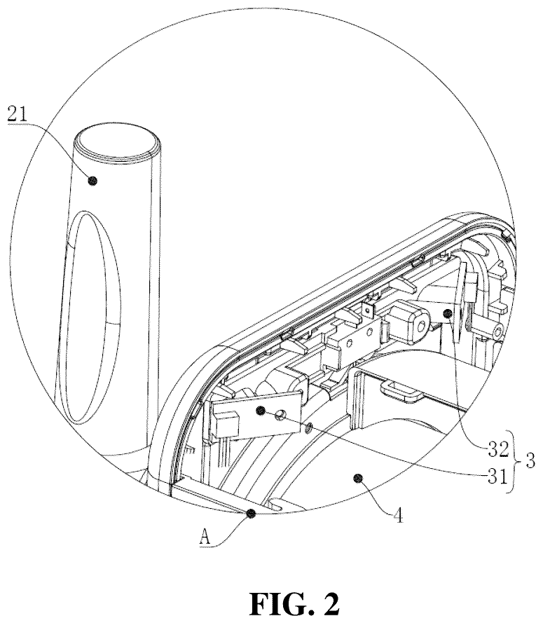

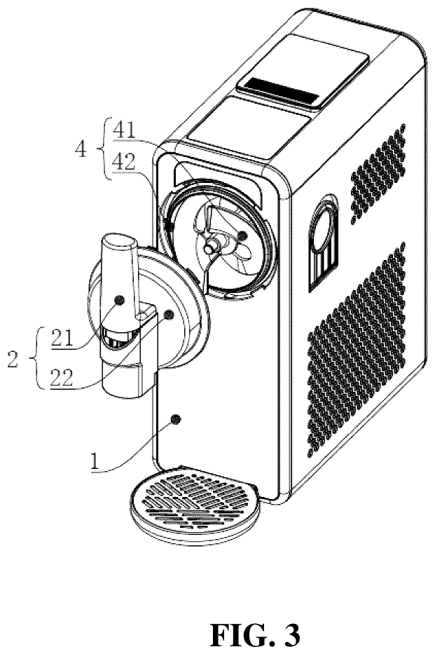

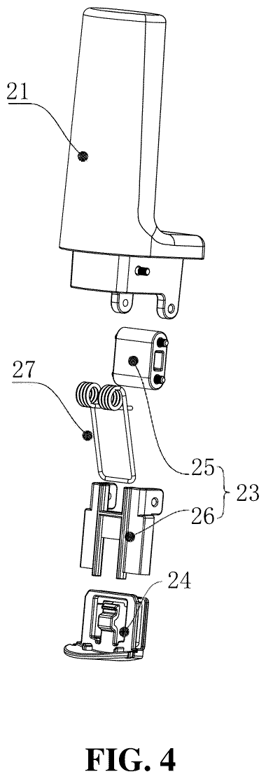

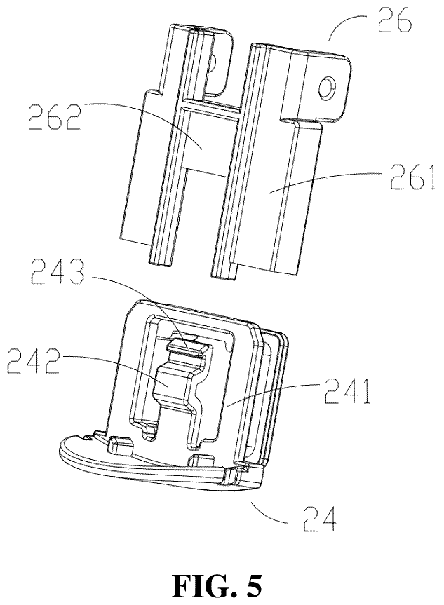

An infrared-sensing cold beverage maker in an embodiment of the present disclosure will be described below with reference to FIG. 1 to FIG. 5.

The infrared-sensing cold beverage maker includes a discharge device 2, a sensing device 3, a refrigeration stirring assembly 4, and a drive that are mounted on a body 1. The discharge device 2 is provided with a handle 21. The sensing device 3 is opposite to the handle 21. The sensing device 3 is electrically connected to the drive. The sensing device 3 is configured to identify a use state of the handle 21, so as to adjust an operating state of the drive. The drive is configured to adjust a stirring speed of the refrigeration stirring assembly 4.

The infrared-sensing cold beverage maker in the embodiment has the following operating process: When the handle 21 is held naturally or swung down slightly, the sensing device 3 captures the action instantaneously and identifies it as a discharge request. Then, the sensing device 3 adjusts the operating state of the drive, and accelerates the stirring speed of the refrigeration stirring assembly 4, so as to ensure that ice cream or smoothie is pushed out uniformly and delicately in a best state. This keeps the original soft mouthfeel of the ice cream or the smoothie, and ensures that each bite of the ice cream or the smoothie can have the best flavor and the best mouthfeel.

When the handle 21 is released, after identifying an initial state of the handle 21, the sensing assembly adjusts the operating state of the drive, and lowers the stirring speed of the refrigeration stirring assembly 4. This prevents texture change or crystal formation of the ice cream or the smoothie for excessive stirring and excessive refrigeration, and further ensures the mouthfeel and flavor of the ice cream or the smoothie.

With cooperation among the sensing device 3, the drive and the refrigeration stirring assembly 4, the present disclosure starts a corresponding working mode only in case of a real discharge requirement. This solves the problem that the stirring system in the conventional cold beverage maker often operates continuously even in case of no discharge requirement to result in deterioration of the ice cream or the smoothie for longtime stirring.

The sensing assembly includes an infrared generator 31 and an infrared receiver 32. The infrared receiver 32 is electrically connected to the drive. The infrared generator 31 is configured to emit infrared light to the handle 21. The infrared receiver 32 is configured to receive infrared light reflected by the handle 21.

The infrared generator 31 emits the infrared light accurately. If the handle 21 is held or the handle 21 is swung down, the infrared light cannot be irradiated on the handle 21 and reflected, and the infrared receiver 32 cannot receive the infrared light reflected by the handle 21. The sensing device 3 adjusts the operating state of the drive according to the signal, and accelerates the stirring speed of the refrigeration stirring assembly 4.

If the handle 21 is released, in response to the initial state of the handle 21, the infrared generator 31 can emit the infrared light to the handle 21, the handle 21 reflects the light, and the infrared receiver 32 can receive the reflected infrared light. By this time, the infrared receiver 32 can adjust the operating state of the drive according to the signal, and lowers the stirring speed of the refrigeration stirring assembly 4, thereby reducing a refrigerating power.

Therefore, with cooperation between the infrared generator 31 and the infrared receiver 32, the present disclosure can accurately determine whether a discharge operation is required by the present cold beverage maker, and correspondingly adjust the operating state of the drive and the operating state of the refrigeration stirring assembly 4. Such an instant response mechanism ensures that the ice cream or the smoothie is pushed out at the best time, keeps the original flavor and mouthfeel of the ice cream or the smoothie, and prevents the unnecessary energy waste.

The infrared generator 31 and the infrared receiver 32 are respectively located at two sides of the handle 21. The infrared generator 31, the infrared receiver 32 and the handle 21 form a triangular structure.

In the embodiment, the infrared generator 31 and the infrared receiver 32 are defined positionally. In response to a non-operating state of the cold beverage maker, even though the cold beverage maker vibrates for an external influence, the infrared generator 31 can emit the infrared light to the handle 21, and the infrared receiver 32 can receive the infrared light reflected by the handle 21, thereby ensuring stability and reliability of the cold beverage maker.

Moreover, when the handle 21 is held or the handle 21 is inclined downward for discharge, the triangular structure can ensure that the infrared receiver 32 cannot receive the infrared light from the infrared generator 31 to improve the operation accuracy of the cold beverage maker.

The refrigeration stirring assembly 4 includes a propeller 41 and a refrigerating cylinder 42. The propeller 41 is rotatably mounted in the refrigerating cylinder 42. A length direction of the propeller 41 is the same as a length direction of the refrigerating cylinder 42. An output end of the drive is fixedly connected to the propeller 41.

The refrigerating cylinder 42 has excellent freezing performance, which can lay a solid foundation for rapid solidification of the ice cream or the smoothie. When the cold beverage is stirred by the propeller 41, a blade of the propeller comes in contact with an inner wall of the refrigerating cylinder 42 to cause heat conduction between the ice cream or the smoothie and the refrigerating cylinder 42 to achieve the refrigerating effect.

In response to a discharged state of the ice cream or the smoothie, a rotational speed of the propeller 41 is accelerated by the drive. This not only ensures that the cold beverage maker can convey the ice cream or the smoothie to the outside stably, but also can make the blade contact the inner wall of the refrigerating cylinder 42 frequently, and greatly increases a heat exchange area between the ice cream or the smoothie and the refrigerating cylinder 42, thereby significantly accelerating release of heat in the ice cream or the smoothie, and improving the overall refrigeration efficiency. Consequently, the ice cream or the smoothie can keep the ideal mouthfeel and the ideal flavor when discharged.

The discharge device 2 further includes a discharge disc 22. The discharge disc 22 is configured to seal the refrigerating cylinder 42. The discharge disc 22 is provided with a first discharge port. The first discharge port communicates with an interior of the refrigerating cylinder 42. A bottom of the handle 21 is provided with a transmission assembly 23 and a sealing element 24. The transmission assembly 23 is connected to the handle 21 and the sealing element 24. The sealing element 24 is configured to open or close the first discharge port.

By swinging the handle 21 down, the handle 21 sequentially drives the transmission assembly 23 and the sealing element 24 to move, such that the first discharge port is opened by the sealing element 24. When sensing the use state of the handle 21, the sensing device 3 adjusts a rotational speed of the drive timely, such that the propeller 41 can stir the ice cream or the smoothie quickly. In this way, the ice cream or the smoothie can keep the desirable mouthfeel and desirable flavor and can further be discharged stably.

When the handle 21 is released, the sensing device 3 can quickly identify restoration of the handle 21, and adjust the rotational speed of the drive accordingly. The propeller 41 stirs the ice cream or the smoothie slowly and intermittently to reduce the phenomenon that the ice cream or the smoothie is deteriorated for longtime stirring.

It is to be noted that the sealing element 24 is preferably made of a food-grade rubber material. The sealing element 24 is closely attached to the first discharge port. This ensures that the ice cream or the smoothie is completely sealed in the refrigerating cylinder 42 when not discharged, to prevent leakage or deterioration of the ice cream or the smoothie for poor sealing.

The transmission assembly 23 includes a first transmission element 25 and a second transmission element 26. The handle 21 includes a first hinge point rotatably mounted on a top of the discharge disc at the first discharge port 22, and a second hinge point rotatably connected to a top of the first transmission element 25. A bottom of the first transmission element 25 is connected to a top of a rear side of the second transmission element 26. A bottom of the second transmission element 26 is fixedly connected to the sealing element 24.

Preferably, the second transmission element 26 is provided with a first sealing clamping member 262 at a rear side of a top of a sealing chute 261. A second sealing clamping member 241 is provided at a front side of a top of the sealing element 24. The first sealing clamping member 262 and the second sealing clamping member 241 are clamped with each other.

Since the second transmission element 26 is provided with the first sealing clamping member 262, and the second sealing clamping member 241 is provided on the sealing element 24, the sealing element 24 can be detachably mounted on the second transmission element 26. When a user needs to perform cleaning, as long as the first sealing clamping member 262 and the second sealing clamping member 241 are separated from each other, the sealing element 24 can be detached quickly for cleaning and replacement.

Preferably, the sealing element 24 includes the second sealing clamping member 241, an elastic protrusion portion 242, and a hook portion 243. The first sealing clamping member 262 is a hook structure with a tail end turned up. The elastic protrusion portion 242 includes a bottom connected to the second sealing clamping member 241, and a top connected to the hook portion 243. The hook portion 243 is clamped with the hook structure.

It is to be noted that when the elastic protrusion portion 242 is pressed, the elastic protrusion portion 242 is recessed, and the elastic protrusion portion 242 drives the hook portion 243 to separate from the hook structure. Then, by pulling the sealing element 24, the sealing element 24 can be detached quickly. When the sealing element 24 is mounted, the sealing element 24 is pushed up, until the hook portion 243 abuts against the hook structure. At this time, by pressing the elastic protrusion portion 242, and pushing up the sealing element 24, the hook portion 243 and the hook structure get close to each other and are clamped with each other, thereby realizing mounting of the sealing element 24.

In an initial state, a direction of a connecting line for the first hinge point and the second hinge point is a horizontal direction.

In the embodiment, the direction of the connecting line for the first hinge point and the second hinge point of the handle 21 is defined. This can effectively ensure that when the handle 21 is swung outward, the handle 21 can sequentially drive the first transmission element 25 and the second transmission element 26 to move. The bottom of the second transmission element 26 drives the sealing element 24 to move, and the first discharge port can be opened by the sealing element 24. The ice cream or the smoothie is squeezed from the refrigerating cylinder 42 to the first discharge port to realize discharge of the ice cream or the smoothie.

By swinging the handle 21 inward, the handle 21 sequentially drives the first transmission element 25, the second transmission element 26 and the sealing element 24 to move, such that the first discharge port is sealed by the sealing element 24 to stop discharge of the ice cream or the smoothie.

Through a cascaded design of the first transmission element 25 and the second transmission element 26, a stable transmission chain is formed. This design improves stability of the transmission, and makes the sealing element 24 move more stably and accurately in the opening and closing process.

The transmission assembly 23 further includes a return torsion spring 27. The return torsion spring 27 sequentially includes a winding portion and a transmission portion from top to bottom. The winding portion is wound on the first hinge point of the handle 21. The transmission portion is fixedly connected to a front side of the second transmission element 26.

When the handle 21 is swung outward, a rear end of the handle 21 is tilted up. The first transmission element 25 can move up, thus driving a rear side of the second transmission element 26 to move up. Meanwhile, the return torsion spring 27 causes deformation under an action of the handle 21, and the transmission portion drives the front side of the second transmission element 26 to move up. By this time, both the front side and the rear side of the second transmission element 26 suffer an upward acting force. The second transmission element 26 drives the sealing element 24 to move up together, to ensure that the first discharge port is opened by the sealing element 24.

When the handle 21 is released, and the handle 21 is restored, the return torsion spring 27 is returned. Under an action of the handle 21, the first transmission element 25 moves down. Under an action of the return torsion spring 27 and the first transmission element 25, the second transmission element 26 moves down, thereby driving the sealing element 24 to move down and close the second discharge port.

The refrigeration stirring assembly 4 further includes a cooling tube. The cooling tube is provided around an outer side of the refrigerating cylinder 42. When the propeller 41 in the refrigerating cylinder 42 stirs the ice cream or the smoothie, the cooling tube works synchronously to take away heat of an outer wall of the refrigerating cylinder 42 through heat conduction, thereby accelerating cooling and solidification of the ice cream or the smoothie. The refrigerating method having the inside and the outside cooperating with each other significantly improves the overall refrigeration efficiency, and shortens the making period of the ice cream or the smoothie.

Moreover, the cooling tube is provided around the outer side of the refrigerating cylinder 42, such that each portion of the refrigerating cylinder 42 can be cooled uniformly. The design prevents the texture difference of the ice cream or the smoothie due to uneven temperature distribution in the refrigerating cylinder 42, and ensures the consistent quality and mouthfeel of the ice cream or smoothie product.

The technical principles of the present disclosure are described above with reference to the specific embodiments. These descriptions are merely intended to explain the principles of the present disclosure, and cannot be construed as limiting the protection scope of the present disclosure in any way. Based on the explanation herein, those skilled in the art may associate other specific implementations of the present disclosure without creative effort, and these implementations should fall within the protection scope of the present disclosure.

1. An infrared-sensing cold beverage maker, comprising a discharge device, a sensing device, a refrigeration stirring assembly, and a drive that are mounted on a body, wherein the discharge device is provided with a handle; the sensing device is opposite to the handle; the sensing device is electrically connected to the drive; the sensing device is configured to identify a use state of the handle, so as to adjust an operating state of the drive; and the drive is configured to adjust a stirring speed of the refrigeration stirring assembly.

2. The infrared-sensing cold beverage maker according to claim 1, wherein the sensing assembly comprises an infrared generator and an infrared receiver; the infrared receiver is electrically connected to the drive; the infrared generator is configured to emit infrared light to the handle; and the infrared receiver is configured to receive infrared light reflected by the handle.

3. The infrared-sensing cold beverage maker according to claim 2, wherein the infrared generator and the infrared receiver are respectively located at two sides of the handle; and the infrared generator, the infrared receiver and the handle form a triangular structure.

4. The infrared-sensing cold beverage maker according to claim 1, wherein the refrigeration stirring assembly comprises a propeller and a refrigerating cylinder; the propeller is rotatably mounted in the refrigerating cylinder; a length direction of the propeller is the same as a length direction of the refrigerating cylinder; and an output end of the drive is fixedly connected to the propeller.

5. The infrared-sensing cold beverage maker according to claim 4, wherein the discharge device further comprises a discharge disc; the discharge disc is configured to seal the refrigerating cylinder; the discharge disc is provided with a first discharge port; the first discharge port communicates with an interior of the refrigerating cylinder; a bottom of the handle is provided with a transmission assembly and a sealing element; the transmission assembly is connected to the handle and the sealing element; and the sealing element is configured to open or close the first discharge port.

6. The infrared-sensing cold beverage maker according to claim 5, wherein the transmission assembly comprises a first transmission element and a second transmission element; the handle comprises a first hinge point rotatably mounted on a top of the discharge disc at the first discharge port, and a second hinge point rotatably connected to a top of the first transmission element; a bottom of the first transmission element is connected to a top of a rear side of the second transmission element; and a bottom of the second transmission element is fixedly connected to the sealing element; and
in an initial state, a direction of a connecting line for the first hinge point and the second hinge point is a horizontal direction.

7. The infrared-sensing cold beverage maker according to claim 6, wherein the transmission assembly further comprises a return torsion spring; the return torsion spring sequentially comprises a winding portion and a transmission portion from top to bottom; the winding portion is wound on the first hinge point of the handle; and the transmission portion is fixedly connected to a front side of the second transmission element.

8. The infrared-sensing cold beverage maker according to claim 4, wherein the refrigeration stirring assembly further comprises a cooling tube; and the cooling tube is provided around an outer side of the refrigerating cylinder.
